(19) United States
(12) Patent Application Publication
(10) Pub. No.: US 2015/0285205 A1
(43) Pub. Date: Oct. 8, 2015

(54) Magneto Front Mount Adapter for Sprint Car Application

(71) Applicants: Gary P. Burkle, Guilford, CT (US); Frank D. Kokai, Clinton, CT (US)

(72) Inventors: Gary P. Burkle, Guilford, CT (US); Frank D. Kokai, Clinton, CT (US)

(21) Appl. No.: 14/645,992

(22) Filed: Mar. 12, 2015

Related U.S. Application Data
(60) Provisional application No. 61/974,654, filed on Apr. 3, 2014.

(51) Int. Cl. F02P 1/00; F02B 67/04; F02B 61/00

(52) U.S. Cl. CPC F02P 1/005; F02B 61/00; F02B 67/04

(57) ABSTRACT

An ignition magneto adapter and, more specifically, an adapter to relocate an ignition magneto from the rear of an engine to the front of an engine. The adapter includes a timing gear cover mounted to the engine, an oil pump adapter in contact with the timing gear cover, and a magneto base adapter having a stem, shaft, and upper and lower bearings, the magneto base adapter being located adjacent to the oil pump adapter and in contact with the timing gear cover, wherein the ignition magneto is located on and supported by the stem of the magneto base adapter.

### FIELD OF THE INVENTION

The present invention generally relates to an ignition magneto and more specifically to a kit to relocate the location of the ignition magneto in an engine in a Sprint Car application.

### BACKGROUND OF THE INVENTION

Sprint cars are high-powered race cars designed primarily for the purpose of running on short oval or circular dirt or paved tracks. Sprint cars have historically used Small Block Chevrolet® engines. The Small Block Chevrolet® engine design incorporates a location for an ignition distributor that is located at the rear of the engine positioned through the intake manifold and down into the engine block where a helical distributor drive gear engages with the helical gear that is machined directly onto the rear of the camshaft. The typical ignition distributor for a Small Block Chevrolet® engine is electrically charged with a 12 volt battery/alternator charging system to charge an ignition coil to create the required spark energy to ignite a fuel/air mixture in a combustion chamber of the engine.

By design, however, in contrast to standard Chevrolet® vehicles, Sprint Car race vehicles are built with weight reduction as a significant concern. Sprint Car race vehicles are built without the typical 12 volt battery/alternator charging system that is present in Small Block Chevrolet® engines, and have eliminated the engine starter in order to save weight. To accomplish starting the engine of Sprint Car race vehicles, these vehicles are started by push-starting with another vehicle.

Furthermore, Sprint Car engines have typically substituted the ignition distributor used in Small Block Chevrolet® engines for an ignition magneto, since electricity is still required to ignite the fuel/air mixture to start the Sprint Car race vehicles. The ignition magneto generates the electricity required to ignite the fuel/air mixture via the spark plug wires in the same fashion as distributor type engine.

The standard magneto has the capability to generate extremely high spark energy, greater than most distributor type ignitions. With this high energy comes the possibility of misfire inside the magneto cap. This cap is similar to a typical distributor cap in that it incorporates 8 terminals spaced apart to provide sufficient distance between teach terminal to prevent a misfire.

There is exists a need to improve upon the prior art design of having Sprint Car race vehicles without the typical 12 volt battery/alternator charging system that is present in Small Block Chevrolet® engines, while providing a reduced weight design to the ignition magneto in Sprint Car race vehicles.

Furthermore, there exists a need to improve upon the standard magneto of the prior art.

### SUMMARY OF THE INVENTION

Accordingly, it is an object of the invention to provide an adapter to mount an ignition magneto to the front of an engine, rather than the rear of the engine as in prior art Sprint Car race vehicles. The inventor of application has discovered that it is advantageous to mount the ignition magneto to the front of an engine, in particular a Small Block Chevrolet® engine.

This is because mounting the ignition magneto to the front of an engine improves the timing accuracy of the magneto. This is achieved through driving the magneto off of the front of the cam, which is driven off of the front of the crankshaft.

In standard operation of the engine and magneto, harmonic pulsations are induced into the magneto as a result of the multiple lobes on the camshaft and the valve train components. These engine components apply torsional strain on the camshaft and harmonic pulsations into the “downstream” magneto, which causes variations in the timing accuracy.

However, by mounting the magneto to the front of the engine and driving the magneto from the front of the camshaft, the timing accuracy is improved by eliminating the harmonics induced into the magneto via the camshaft.

Moreover, by ting the magneto to the front of the engine, the engine builder is able to use a higher output magneto for increases in spark energy.

Additional advantages of mounting the ignition magneto in the front of the engine are due to spatial limitations at the rear (original) location of the engine, as the original location suffers from size constraints.

These and other objects of the invention are achieved by providing an adapter for mounting an ignition magneto to an engine, the kit comprising: a timing gear cover having a proximal end and a distal end, the proximal end of the timing gear cover being mounted to the engine; an oil pump adapter having a proximal end and a distal end, the proximal end of the oil pump adapter being in contact with the distal end of the timing gear cover; and a magneto base adapter having a stem, shaft, and upper and lower bearings, the magneto base adapter being located adjacent to the oil pump adapter and in contact with the distal end of the timing gear cover, wherein the ignition magneto is located on and supported by the stem of the magneto base adapter.

In certain embodiments, the adapter further comprises a camshaft gear adapter, the camshaft gear adapter being adapted to interact with a front drive camshaft gear.

In certain embodiments, the adapter further comprises a helical gear, the helical gear meshing with the camshaft gear adapter.

In certain embodiments, the adapter further comprises a water pump, wherein the water pump is in contact with the distal end of the timing gear cover.

In certain embodiments, the ignition magneto is a downstream magneto, which causes variations in the timing accuracy.

In certain embodiments, the ignition magneto is used for a Sprint Car engine.

In certain embodiments, the ignition magneto is driven off the front of a cam, which is driven off the front of a crankshaft.

In certain embodiments, the timing gear cover includes at least one bore, the at least one bore having a reduced diameter, whereby the circumference of the bore is reduced along the length of the bore.

In certain embodiments, the oil pump adapter includes a bore that mates with a bore in the timing gear cover. In certain embodiments, separate pressure hoses are plumbed from an oil pump pressure outlet to the engine inlet, which is located at the rear of the engine.

In certain embodiments, the timing gear cover includes a support portion for supporting the magneto base adapter. In certain embodiments, the support portion supports a sealing ring, which mates with the bottom of the stem.

In certain embodiments, sealing elements are provided to connect the stem and shaft to one another. In certain embodiments, the sealing elements are O-rings.

In certain embodiments, the adapter further comprises an adapter shaft assembly to mount the oil pump adapter to the timing gear cover.

In certain embodiments, the adapter shaft assembly comprises a connection element having a circular flange that fits within bore in the timing gear cover.

In certain embodiments, a rear distributor location replacement stem is provided, which is installed in the original magneto/distributor location. The rear distributor location replacement stem provides for continuity of the factory oil gallery.

Other objects of the invention are achieved by providing a kit for relocating an ignition magneto from a rear location of an engine to the front of the engine, the kit comprising: a timing gear cover having a proximal end and a distal end, the proximal end of the timing gear cover being mounted to the engine; an oil pump adapter having a proximal end and a distal end, the proximal end of the oil pump adapter being in contact with the distal end of the timing gear cover; and a magneto base adapter having a stem, shaft, and upper and lower bearings, the magneto base adapter being located adjacent to the oil pump adapter and in contact with the distal end of the timing gear cover; and a rear distributor location replacement stem, wherein the ignition magneto is located on and supported by the stem of the magneto base adapter.

In certain embodiments, the rear distributor location replacement stem is installed in the rear location of the engine.

In certain embodiments, the kit further comprises a camshaft gear adapter, the camshaft gear adapter being adapted to interact with a front drive camshaft gear.

In certain embodiments, the kit further comprises a helical gear, the helical gear meshing with the camshaft gear adapter.

In certain embodiments, the kit further comprises a water pump, wherein the water pump is in contact with the distal end of the timing gear cover.

Other objects of the invention are achieved by providing a kit and/or adapter to relocate the magneto from the rear (original) location of the Chevrolet® engine to the front of the engine. This kit will incorporate a timing gear cover, a camshaft gear adapter, a magneto base adapter with stem, shaft, upper and lower bearings, helical gear to mesh with the front drive camshaft gear, a front mount oil pump adapter, and a water pump. The magneto base adapter may accommodate commonly used racing magnetos.

In certain embodiments, the kit includes a rear distributor location replacement stem. This is installed in the original magneto/distributor location and provides for continuity of the factory oil gallery.

Other objects of the invention provide a method for relocating an ignition magneto from a rear location of an engine to the front of the engine. The method involves providing a timing gear cover having a support portion, and a magneto base adapter having a stem, shaft, and upper and lower bearings; mounting the magneto base adapter on the support portion of the timing gear cover; and mounting the ignition magneto on the stem of the magneto base adapter. In certain embodiments, the engine is a Chevrolet® engine or a Small Block Chevrolet® engine.

In certain embodiments of the invention, the method involves connecting the timing gear cover to the engine.

In certain embodiments, the method involves connecting the oil pump adapter to the timing gear cover and to the magneto base adapter.

Other objects of the invention provide an adapter for relocating an ignition magneto from a rear location of an engine to the front of the engine comprising a mount and a support for the mount to mount the ignition magneto to the front of the engine. In certain embodiments, the adapter includes means for mounting the ignition magneto to the front of the engine.

Other objects of the invention and its particular features and advantages will become more apparent from consideration of the following drawings and accompanying detailed description. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

FIG. 1A is left side view of an adapter of an embodiment of the present invention;

FIG. 1B is a front view of the adapter of FIG. 1A;

FIG. 1C is a right side view of the adapter of FIG. 1A;

FIG. 2 is an exploded view of the adapter shown in FIG. 1A;

FIG. 3 is a left side schematic view of the adapter of FIG. 1A mounted on an engine;

FIG. 4 is a top side view of the adapter of FIG. 1A mounted on an engine;

FIG. 5 is a right side view of the adapter of FIG. 1A mounted on an engine;

FIG. 6 is a schematic view of an ignition magneto mounted to the adapter of FIG. 1A;

FIG. 7 is a schematic view of the magneto base adaptor of FIG. 1A; and

FIG. 8 is a schematic view of an oil pump hex drive with cam gear magneto drive (hidden) attached to the front of the camshaft of an embodiment of the invention.

### DETAILED DESCRIPTION OF THE INVENTION

The present invention is directed to an adapter to mount an ignition magneto to the front of an engine. The Applicant has discovered that it is advantageous to mount the ignition magneto to the front of an engine, in particular a Small Block Chevrolet® engine.

This is because mounting the ignition magneto to the front of an engine improves the timing accuracy of the magneto. By mounting the magneto to the front of the engine and driving the magneto from the front of the camshaft, the timing accuracy is improved by eliminating the harmonics induced into the magneto via the camshaft.

Moreover, by ting the magneto to the front of the engine, the engine builder is able to use a higher output magneto for increases in spark energy.

Additional advantages of mounting the ignition magneto in the front of the engine are due to spatial limitations at the rear (original) location of the engine, as the original location suffers from size constraints.

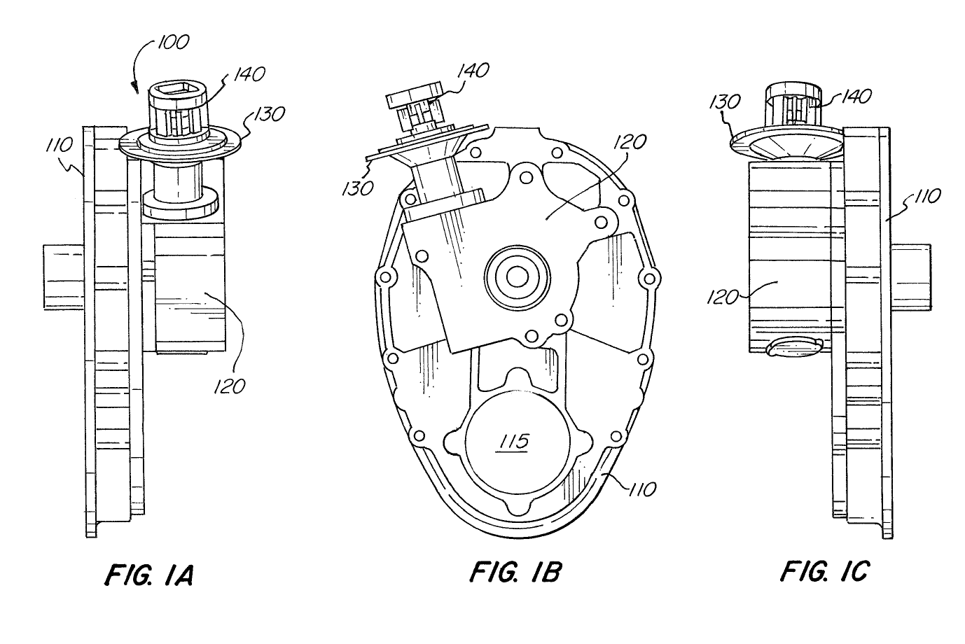

Turning now in detail to the drawings, FIG. 1A, FIG. 1B and FIG. 1 are three schematic views of an adapter 100 of an embodiment of the present invention. FIG. 1A is left side view of the adapter 100, FIG. 1B is a FIG. 1B is a front side view of the adapter 100 and FIG. 1C is a right side view of the adapter 100.

In FIG. 1A, a left side view of the adapter 100 is shown whereby the timing gear cover 110 is shown connected to the oil pump adapter 120. The stem 130 is shown hidden behind the oil pump adapter 120. The ignition magneto base adapter 140 is shown mounted on the stem 130. As shown, the oil pump adapter 120 is flush against the timing gear cover 110 and has a good seal with the timing gear cover 110. The timing gear cover 110 is able to be mounted or connected to an engine. The timing gear cover 110 has multiple bores that allow various fluids (such as water or oil, for example) to pass from various pumps to circulate within the engine.

In FIG. 1B, the oil pump adapter 120 and timing gear cover 110 are shown as well as stem 130 and ignition magneto adapter 140. A large bore 115 in the timing gear cover is shown. Also shown is an oil pump hex drive within the oil pump adapter.

In FIG. 1C, a right side view of the adapter 100 is shown. Here, the timing gear cover 110 is shown connected to the oil pump adapter 120. The stem 130 is shown hidden behind the oil pump adapter 120 and the ignition magneto adapter 140 is shown mounted on the stem 130.

In FIGS. 1A-1C, the adapter 100 is configured to be mounted on the front of an engine, such as a Sprint car engine.

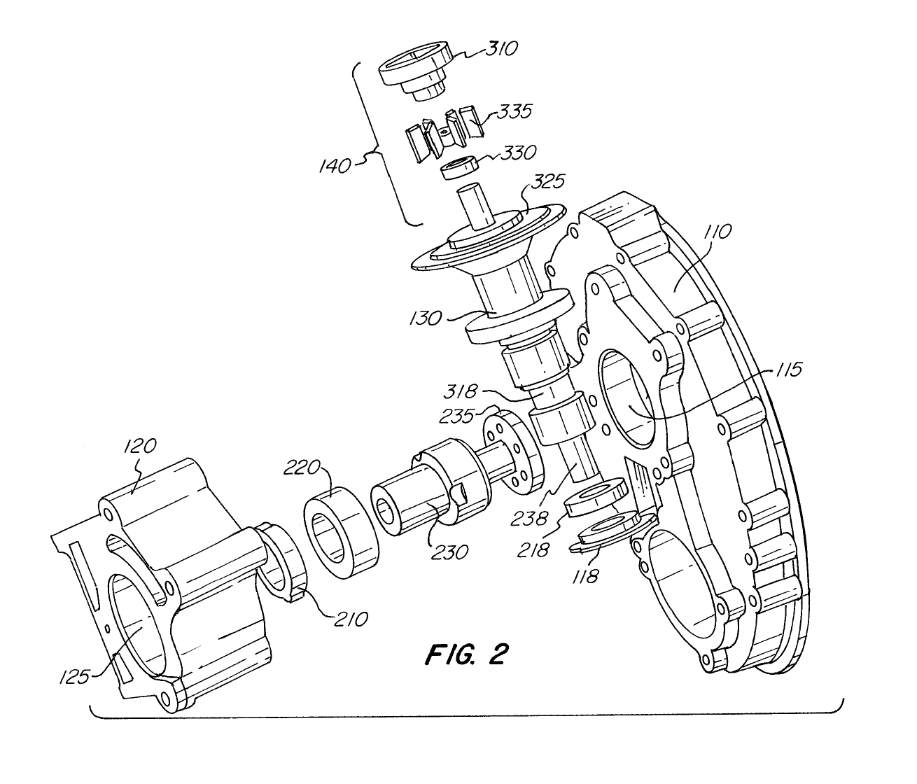

In FIG. 2, an exploded view of the adapter 100 of FIG. 1A is shown. The oil pump adapter 120 is shown as the left most element of FIG. 2. The oil pump adapter 120 is shown having multiple bores throughout. A main bore 125 (the largest shown bore) is a clearance bore for the oil pump shaft to pass through and engage the oil pump shaft with the adapter shaft assembly (210, 220, 230).

The adapter shaft assembly includes connection elements 210, 220 and 230. The connection elements 210, 220 and 230 help connect or mount the oil pump adapter 120 to the timing gear cover 110 as the connection element 230 has a circular flange that fits within bore 115 in the timing gear cover 110. The timing gear cover in FIG. 2 may include multiple bores.

Connection element 210 and 220 are shown as being sealing rings (such as an O-ring) to seal the oil pump adapter 120 to the connection element 230, so that the oil pump adapter 120 is mounted on the timing gear cover 110.

Also shown in FIG. 2, is base or supporting portion 118, which is mounted on the timing gear cover 110. The base 118 supports the stem 130, which mounts the ignition magneto. The base is machined to be fastened to the timing gear cover or to the front of an engine.

The base 118 is shown supporting a sealing ring 218, which mates with the bottom of the stem 238 (lower bearing). Also shown is helical gear portion 318 which meshes with the front drive camshaft gear.

The stem 130 is shown having upper bearing 325 that supports the magneto base adapter 140. The magneto base adapter 140 is made of a sealing ring 330, and elements 335 and 340, which mount the ignition magneto.

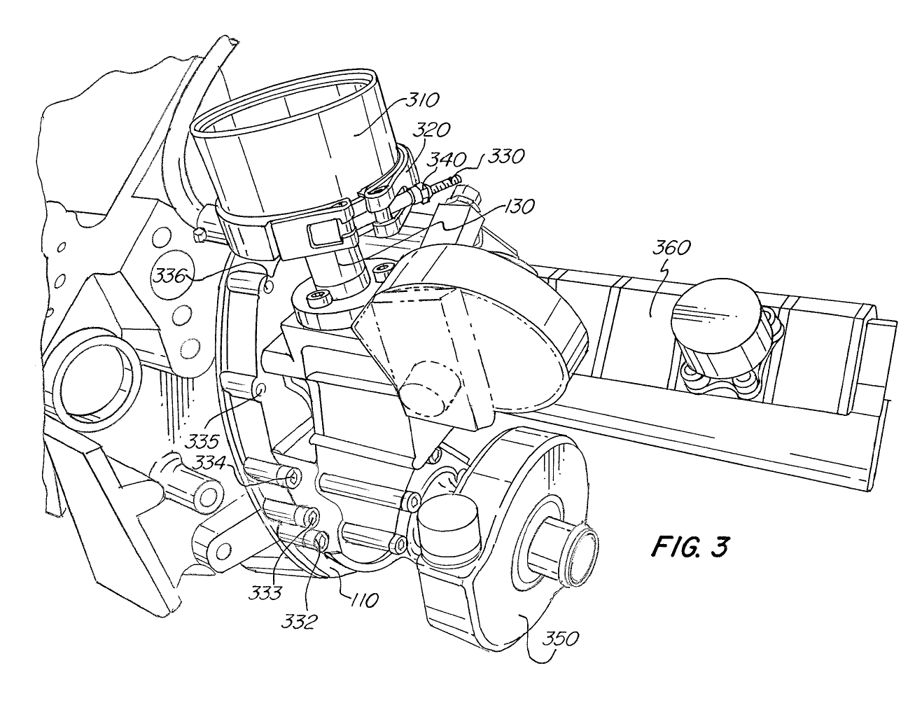

FIG. 3 is a left side schematic view of the adapter 100 mounted onto the engine. Shown in FIG. 3 is timing gear cover 110, connected to the engine and to water pump 350. Also shown is oil pump 360 connected to the timing gear cover 110 via the oil pump adapter 120. The stem 130 and an outer housing 310, which can accept an ignition magneto are also shown.

Also shown in FIG. 3 is clamp 320 having a fastening member 330. The clamp 320 and fastening member 330 are used to hold the outer housing 310 in place to accept the magneto base adapter 140. The fastening member may have be a threaded bolt 330 ridges that is accepted by a nut 340 to fasten and tighten the clamp 320 to hold the outer housing 310 in place.

Also shown in FIG. 3, are bores 332, 333, 334, 335 and 336 in the timing gear cover 110, the bores having fasteners inserted into them to secure the timing gear cover 110 to an engine. While five bores are shown in the timing gear cover 110, a greater or lesser amount of bores may be provided to secure the timing bear cover 110 to the engine.

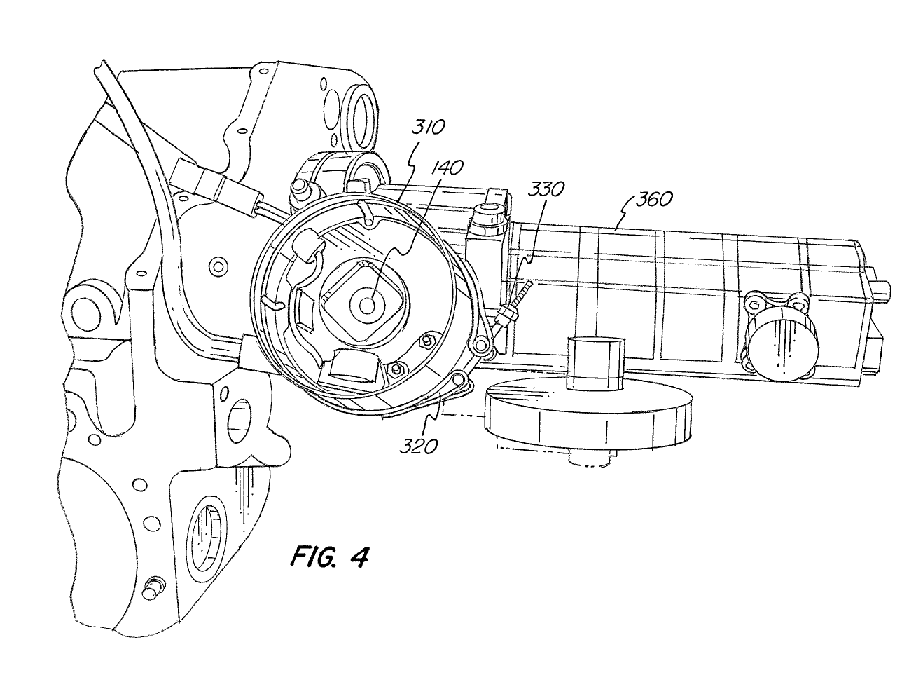

FIG. 4 is a top side view of the magneto base adapter 140 as well as oil pump 360. The magneto base adapter 140 is shown within outer housing 310, the outer housing 410 being able to mate with and accept an ignition magneto.

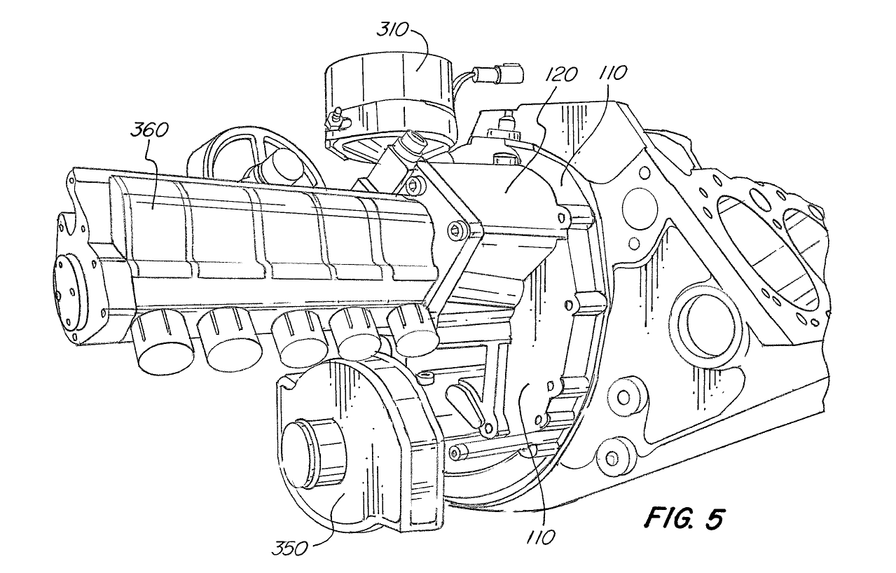

FIG. 5 is a right side view of the adapter 100 showing the timing gear cover 110, oil pump adapter 120, water pump 350 and oil pump 360. These elements are shown connected to an engine.

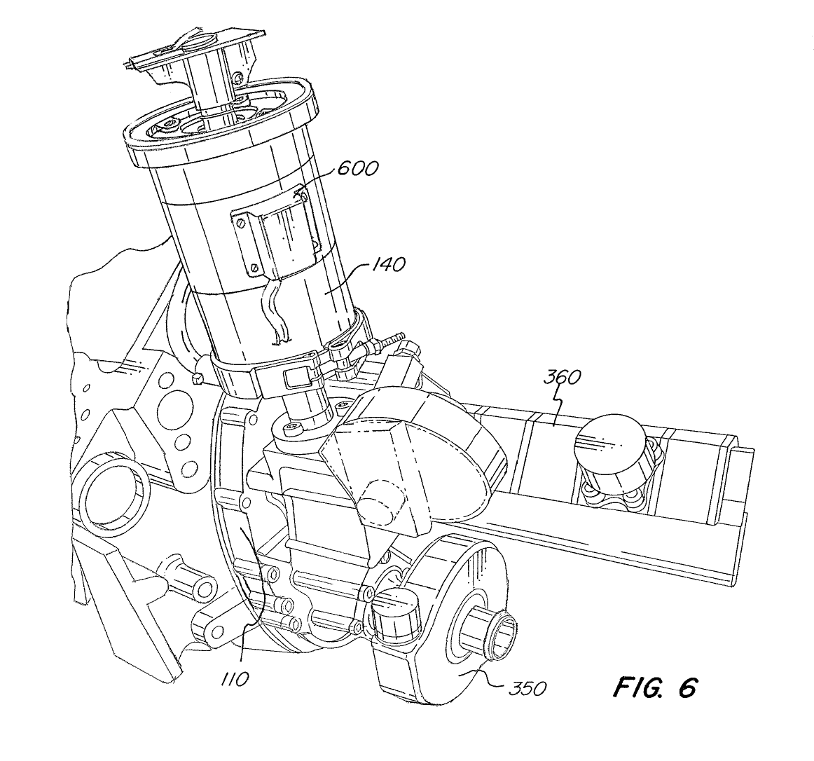

FIG. 6 is a schematic view of the ignition magneto 600 mounted to the magneto base adapter 140. In FIG. 6 the magneto base adapter 140 is shown supporting the ignition magneto 600, such that the ignition magneto 600 is shown mounted on outer housing 310. The oil pump 360, water pump 350, timing gear cover 110 and oil pump adapter 120 are also shown in FIG. 6.

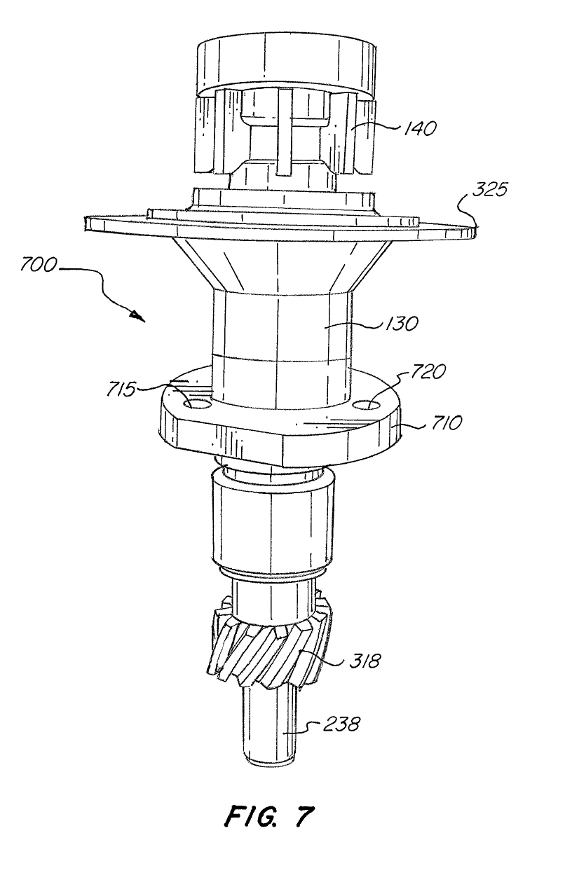

FIG. 7 is a schematic view of the ignition magneto adapter 700. FIG. 7 shows magneto base adapter 140 connected to the stem 130. Also shown is upper bearing 325 and lower bearing 238 as well as the helical gear 318 that meshes with the front drive camshaft gear. The stem 130 is mounted on a support portion that is connected to the timing gear cover 110 or to the front of an engine.

In FIG. 7, the helical gear 310 has ridges to interact with the front drive camshaft gear. Also shown is flange 710 having bores 715 and 720, where fastening members can pass through the bores to secure the ignition magneto adapter 700 to the timing gear cover 110.

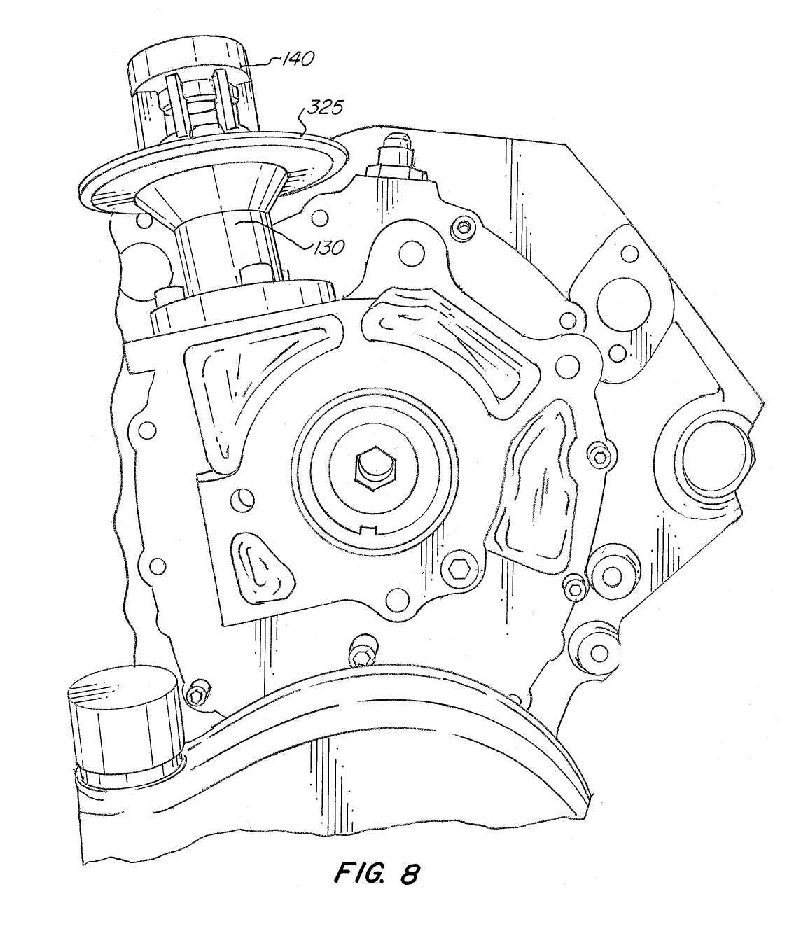

FIG. 8 is a schematic view of an oil pump hex drive with cam gear magneto drive (hidden) attached to the front of the camshaft. The oil pump has been removed for clarity. FIG. 8 shows the stem and the bore within the oil pump adapter 120 that connects the oil pump to the timing gear cover and the engine.

While the invention has been specifically described in connection with certain specific embodiments thereof, it is to be understood that this is by way of illustration and not of limitation, and that various changes and modifications in form and details may be made thereto, and the scope of the appended claims should be construed as broadly as the prior art will permit.

The description of the invention is merely exemplary in nature, and, thus, variations that do not depart from the gist of the invention are intended to be within the scope of the invention. Such variations are not to be regarded as a departure from the spirit and scope of the invention.

What is claimed is:

1. An adapter for mounting an ignition magneto to an engine, the kit comprising:
a timing gear cover having a proximal end and a distal end, the proximal end of the timing gear cover being mounted to the engine;
an oil pump adapter having a proximal end and a distal end, the proximal end of the oil pump adapter being in contact with the distal end of the timing gear cover; and
a magneto base adapter having a stem, shaft, and upper and lower bearings, the magneto base adapter being located adjacent to the oil pump adapter and in contact with the distal end of the timing gear cover,
wherein the ignition magneto is located on and supported by the stem of the magneto base adapter.

2. The adapter of claim 1, further comprising a camshaft gear adapter, the camshaft gear adapter being adapted to interact with a front drive camshaft gear.

3. The adapter of claim 2, further comprising helical gear, the helical gear meshing with the camshaft gear adapter.

4. The adapter of claim 1, further comprising a water pump, wherein the water pump is in contact with the distal end of the timing gear cover.

5. The adapter of claim 1, wherein the ignition magneto is a downstream magneto, which causes variations in the timing accuracy.

6. The adapter of claim 1, wherein the ignition magneto is used for a Sprint Car engine.

7. The adapter of claim 1, wherein the ignition magneto is driven off the front of a cam, which is driven off the front of a crankshaft.

8. The adapter of claim 1, wherein the timing gear cover includes at least one bore, the at least one bore having a reduced diameter, whereby the circumference of the bore is reduced along the length of the bore.

9. The adapter of claim 1, wherein the oil pump adapter includes a bore that mates with a bore in the timing gear cover, such that oil passes through said oil pump adapter and said timing gear cover.

10. The adapter of claim 1, wherein the timing gear includes a support portion for supporting the magneto base adapter.

11. The adapter of claim 10, wherein the support portion supports a sealing ring, which mates with the bottom of the stem.

12. The adapter of claim 1, further comprising an adapter shaft assembly to mount the oil pump adapter to the timing gear cover.

13. The adapter of claim 12, wherein the adapter shaft assembly comprises a connection element having a circular flange that fits within bore in the timing gear cover.

14. A kit for relocating an ignition magneto from a rear location of an engine to the front of the engine, the kit comprising:
a timing gear cover having a proximal end and a distal end, the proximal end of the timing gear cover being mounted to the engine;
an oil pump adapter having a proximal end and a distal end, the proximal end of the oil pump adapter being in contact with the distal end of the timing gear cover; and
a magneto base adapter having a stem, shaft, and upper and lower bearings, the magneto base adapter being located adjacent to the oil pump adapter and in contact with the distal end of the timing gear cover; and
a rear distributor location replacement stem,
wherein the ignition magneto is located on and supported by the stem of the magneto base adapter.

15. The kit of claim 14, wherein the rear distributor location replacement stem is installed in the rear location of the engine.

16. The kit of claim 14, further comprising a camshaft gear adapter, the camshaft gear adapter being adapted to interact with a front drive camshaft gear.

17. The kit of claim 16, further comprising helical gear, the helical gear meshing with the camshaft gear adapter.

18. The kit of claim 14, further comprising a water pump, wherein the water pump is in contact with the distal end of the timing gear cover.

19. A method relocating the magneto from the rear location of an engine to the front of the engine, the method comprising:
providing a timing gear cover having a support portion, and a magneto base adapter having a stem, shaft, and upper and lower bearings;
mounting the magneto base adapter on the support portion of the timing gear cover; and
mounting the ignition magneto on the stem of the magneto base adapter.
